(19) United States
(12) Patent Application Publication
(10) Pub. No.: US 2013/0091050 A1
(43) Pub. Date: Apr. 11, 2013

(54) SYSTEM AND METHOD FOR PROVIDING CREDIT TO UNDERSERVED BORROWERS

(71) Applicants: DOUGLAS MERRILL, LOS ANGELES, CA (US); SHAWN BUDDLE, EVANSTON, IL (US); KASIA CHMIELINKSI, LOS ANGELES, CA (US)

(72) Inventors: DOUGLAS MERRILL, LOS ANGELES, CA (US); SHAWN BUDDLE, EVANSTON, IL (US); KASIA CHMIELINKSI, LOS ANGELES, CA (US)

(21) Appl. No.: 13/454,970

(22) Filed: Apr. 24, 2012

Related U.S. Application Data
(60) Provisional application No. 61/545,496, filed on Oct. 10, 2011.

(51) Int. Cl. G06Q 40/02

(52) U.S. Cl. 705/38

(57) ABSTRACT

A preferred method for providing credit to an underserved borrower can include generating a borrower dataset at a first computer in response to receipt of a borrower profile; formatting the borrower dataset into a plurality of variables; and independently processing each of the plurality of variables using one of a statistical algorithm or a machine learning algorithm to generate a plurality of independent decision sets. The preferred method can further include ensembling the plurality of independent decision sets to generate a model question set; and transmitting the model question set to a second computer from which a user can direct one or more questions in the model question set to a borrower.

### CLAIM OF PRIORITY

The present application claims priority to U.S. Provisional Patent Application Ser. No. 61/545,496, entitled “Using Machine Learning to Guide Human Questioning in Underbanked Underwriting” and filed on 10 Oct. 2011, which is hereby incorporated in its entirety by this reference.

### TECHNICAL FIELD

This invention relates generally to the personal finance and banking field, and more particularly to the field of electronic or computer-based determination of the creditworthiness or underwriting risks associated with a prospective borrower.

### BACKGROUND AND SUMMARY

People use credit daily for purchases large and small. However, there are literally millions of individuals who do not have access to traditional credit—the so-called “underbanked”—who must survive day-to-day without such support from the financial and banking industries. Some enterprises, such as payday loan stores, have dealt with this issue by allowing store personnel handle all or substantially all of the underwriting decisions. This model relies heavily on human judgment, and is thus prone to substantial underwriting error, which in turn is compensated for by charging the borrowers extremely high interest rates. On the other end of the spectrum, typical underwriting enterprises are simply unable to grant credit to individuals who do not already have access to credit, thereby eliminating access to the underbanked entirely. Individuals without existing credit typically do not have and/or cannot provide reliable information upon which the typical underwriting establishment can rely in making its decisions. To the extent that a typical underwriting can actually discover data relating to the borrower's finances, such data is most usually of suspect quality or veracity.

In a sharp departure from the existing business models, the present invention provides a system and method for providing credit to underserved borrowers. One preferred method for providing credit to an underserved borrower can include generating a borrower dataset at a first computer in response to receipt of a borrower profile; formatting the borrower dataset into a plurality of variables; and independently processing each of the plurality of variables using one of a statistical algorithm or a machine learning algorithm to generate a plurality of independent decision sets. As described below, the preferred method can further include ensembling the plurality of independent decision sets to generate a model question set; and transmitting the model question set to a second computer from which a user can direct one or more questions in the model question set to a borrower. Other variations, features, and aspects of the system and method of the preferred embodiment are described in detail below with reference to the appended drawings.

### BRIEF DESCRIPTION OF THE FIGURES

FIG. 1 is a schematic block diagram of a system for providing credit to underserved borrowers in accordance with a preferred embodiment of the present invention.

FIG. 2 is a schematic block diagram of a variation of the preferred system for providing credit to underserved borrowers.

FIG. 3 is a schematic block diagram of another variation of the preferred system for providing credit to underserved borrowers.

FIG. 4 is a flowchart depicting a method for providing credit to underserved borrowers in accordance with a preferred embodiment of the present invention.

FIG. 5 is a flowchart depicting a variation of the preferred method for providing credit to underserved borrowers.

FIG. 6 is a flowchart depicting another variation of the preferred method for providing credit to underserved borrowers.

FIG. 7 is a flowchart depicting another variation of the preferred method for providing credit to underserved borrowers.

FIG. 8 is a flowchart depicting another variation of the preferred method for providing credit to underserved borrowers.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

### Preferred System

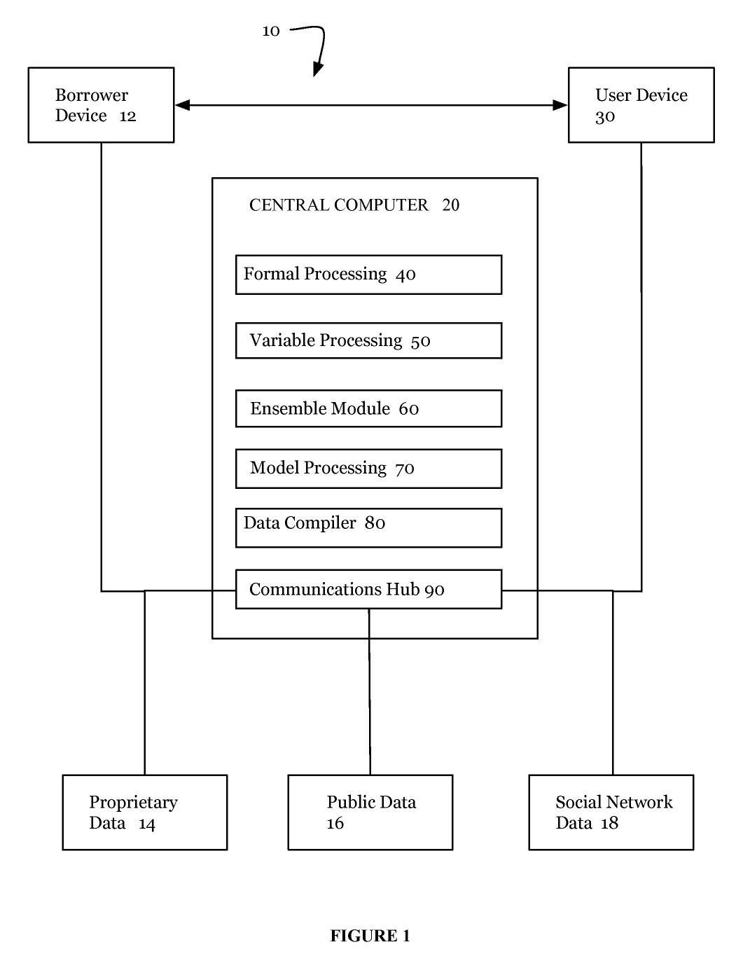

As shown in FIG. 1, an operating environment for providing credit to underserved borrowers in accordance with a preferred embodiment can generally include a borrower device 12, a user device 30, a central computer 20, and one or more data sources, including for example proprietary data 14, public data 16, and social network data 18. The preferred system 10 can include at least a central computer 20 and/or a user device 30, which (individually or collectively) function to provide a borrower with access to credit based on a novel and unique set of metrics derived from a plurality of novel and distinct sources. In particular, the preferred system 10 functions to provide credit to underserved borrowers, also known as the underbanked, by accessing, evaluating, measuring, quantifying, and utilizing a measure of creditworthiness based on the novel and unique methodology described below.

As shown in FIG. 1, the preferred system 10 can interact with and/or receive data from a borrower device 12. The borrower device 12 preferably functions to assemble, aggregate, receive, compile, store, and/or transmit a borrower profile for receipt and analysis by the preferred system 10. The borrower profile can include any suitable biographical and financial data that is usable in determining a borrowing risk profile of the borrower. In one variation of the preferred system 10, the borrower interfaces with the system 10 through his or her borrower device 12, which can include a desktop computer, laptop computer, tablet computer, smart phone, personal digital assistant, or any other suitable networking device. For example, the borrower device 12 can include a desktop computer having a web browser or stand-alone application configured to interface with and/or distribute the borrower profile to one or more components of the preferred system 10. Preferably, some or all of the components of the preferred system 10 are connectable and communicable through a network (not shown), which can include any suitable combination of the global Internet, a wide area network (WAN), a local area network (LAN), and/or a near field network, as well as any suitable networking software, firmware, hardware, routers, modems, cables, transceivers, antennas, and the like. Preferably, some or all of the components of the preferred system 10 can access the network through wired or wireless means, and using any suitable communication protocol/s, layers, addresses, types of media, application programming interface/s, and/or supporting communications hardware, firmware, and/or software. In other variations of the preferred system 10, the borrower profile can be acquired from the borrower through personal interviewing without using the borrower device 12.

As shown in FIG. 1, the preferred system 10 can further include a central computer 20 that preferably functions to receive the borrower profile, either directly from the borrower device 12 or through direct input by a user following an interview with the borrower. The central computer 20 preferably further functions to control, manage, maintain, distribute, aggregate, store, compile and/or communicate any processing of the borrower profile as well as any results, metrics, or measurements derived from processing the borrower profile. The preferred central computer 20 can include one or more machines, modules, servers, databases, clusters, virtual machines, and/or cloud-based instances configured for performing the predetermined tasks set forth below. Preferably, the central computer 20 is connectable to a user device 30 and one or more databases or servers containing information relating to the borrower, including for example proprietary data 14, public data 16, and/or social network data 18, any or all of which can reside on and/or be accessible through a standard Internet connection. The preferred central computer 20 can include one or more sub-components or machines configured for receiving, manipulating, configuring, analyzing, synthesizing, communicating, and/or processing data associated with the borrower, including for example: a formal processing unit 40, a variable processing unit 50, an ensemble module 60, a model processing unit 70, a data compiler 80, and a communications hub 90. Any of the foregoing sub-components or machines can optionally be integrated into a single operating unit, or distributed throughout multiple hardware entities through networked or cloud-based resources.

As shown in FIG. 1, the preferred system 10 can interface with one or more types of raw datasets, including proprietary data 14, public data 16, and/or social network data 18. The raw datasets preferably function to accumulate, store, maintain, and/or make available biographical, financial, and/or social data relating to the borrower. In one example embodiment, the proprietary data 14 can include a borrower's computed credit rating (FICO score) from any suitable credit rating agency available in the United States or abroad. Preferably, the proprietary data 14 can be acquired by payment of a fee to a credit rating agency during a so-called credit check. In the example embodiment, the public data 16 can include any publicly available information on any website connected to the Internet and relating in any manner to the biographical or financial status of the borrower. Preferably, the public data 16 is available for free or at a nominal cost through one or more search strings, automated crawls, or scrapes using any suitable searching, crawling, or scraping process, program, or protocol. In the example embodiment, the social network data 18 can include any data related to a borrower profile and/or any bogs, posts, tweets, links, friends, likes, connections, followers, followings, pins (collectively a borrower's social graph) on a social network. Additionally, the social network data 18 can include any social graph information for any or all members of the borrower's social network, thereby encompassing one or more degrees of separation between the borrower profile and the data extracted from the social network data 18. Preferably, the social network data 18 is available for free or at a nominal cost through direct or indirect access to one or more social networking and/or bogging websites, including for example Google+, Facebook, Twitter, LinkedIn, Pinterest, tumblr, blogspot, Wordpress, and Myspace. Collectively, the raw datasets 14, 16, 18 can provide tens of thousands of data points from dozens of data sources to the preferred system 10 in a substantially instantaneous manner (e.g., approximately one to two seconds or less per borrower).

As shown in FIG. 1, one aspect of the preferred system 10 is a formal processing unit 40 that preferably functions to transform any or all of the data acquired from the raw datasets 14, 16, 18 into an optimized format. Raw datasets are preferably acquired in any suitable form, including their respective native forms, which may or may not be amenable to systematic processing. The formal processing unit 40 preferably receives the raw data, which can include data in the form of strings, true/false flags, counters, URLs, borrower social graphs, borrower's friends' social graphs, and the like. The formal processing unit 40 preferably organizes and/or quantizes each of the raw data formats into an appropriate data distribution for statistical and/or machine learning processing. For example, data relating to a borrower's address can contain valuable underwriting data, such as the number of residences the borrower has listed in a predetermined period. Address data can be derived from the borrower profile, proprietary data 14, public data 16, and/or social network data 18. If the address data is not identical, the format of the address data is transformed by the formal processing unit 40 such that a useful statistical analysis can be performed. For example, the preferred system 10 can utilize Jaccard distances to determine the likelihood that two listed addresses are in fact the same address. As Jaccard distances are distributed as a power law, the preferred system 10 can employ one or more log-normal transformations to be enable traditional statistical analysis. Alternatively, the preferred system 10 can employ other statistical algorithms, including for example a Mahalanobis distance measure, a Hamming distance measure, a non-normally distributed distance measure, a traditional Euclidean distance measure, a high-order distance measures, and/or a Cosine transform. In another example, a borrower's bankruptcy history is also of interest to potential underwriters. Underbanked borrowers in particular are likely to have one or more prior bankruptcies (at least one cause of their underbanked status). In one example implementation of the preferred system 10, a single bankruptcy can have little to no effect on the borrower's potential status. Conversely, two or more bankruptcies can merit further consideration as the preferred system 10 treats bankruptcy as a power law distribution. Preferably, the preferred system 10 addresses both the number of total bankruptcy filings as well as the time since the last bankruptcy filing. The formal processing unit 40 preferably transforms and compiles each of the data entries into a suitable number of variables that are representative of the credit risk of the borrower. In the example implementation of the preferred system 10 described above, the formal processing unit 40 can generate thousands of variables from the combined data representing the borrower's biography and financial condition.

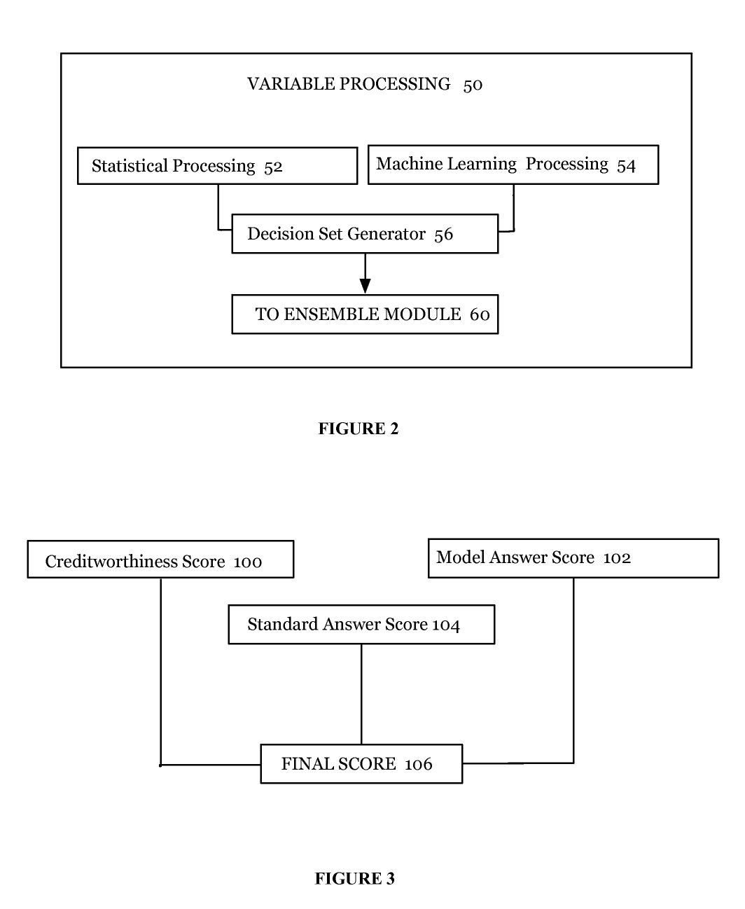

As shown in FIGS. 1 and 2, the preferred system 10 can further include a variable processing unit 50, which preferably functions to receive the plurality of variables generated by the formal processing unit 40 and calculate, determine, compute, and/or generate a plurality of independent data sets representative of the borrower's underwriting risk. Preferably, the variable processing unit 50 performs one or more of statistical processing or machine learning processing in order to generate independent data sets that can be analyzed, combined, weighted, and/or modified singly or jointly to assess the borrower's underwriting risk. As shown in FIG. 2, in one variation of the preferred system 10, the variable processing unit 50 can include a statistical processor 52, a machine learning processor 54, and a decision set generator 56. In another variation of the preferred system 10, the variable processing unit 50 can include several dozen statistical processors 52 and several dozen machine learning processors 54, all of which can be independently fed into the decision set generator 56. Suitable statistical processors 52 can include logistic regression models, item-response theory models, structural equation models, Bayesian networks, naïve Bayesian models, general linear models, Euclidean distance metrics, non-Euclidean distance metrics, collaborative filtering, and/or K-means clustering. Suitable machine learning processors 54 can include decision trees, naïve Bayesian models, random forest algorithms, a graph theoretical algorithm, a swarm algorithm, a simulated annealing algorithm, support vector machines, expectation maximization-based clustering models, hill climbing models, artificial neural networks, various algorithms using a kernel trick to redistribute values, non-negative matrix factorization, and/or genetic algorithms. For example, a support vector machine is suitable for eliminating borrower's with extreme risk values; and a naïve Bayesian model is suitable for overcoming missing data that for one reason or another is not captured or available to the preferred system 10.

As shown in FIG. 2, results from each of the statistical processor/s 52 and the machine learning processor/s 54 are preferably fed into a decision set generator 56. The decision set generator 56 preferably functions to receive and organize each independent evaluation from each of the statistical processor/s 52 and the machine learning processor/s 54 for delivery to the ensemble module 60. Each of the decisions/actions derived from the statistical processor/s 52 and the machine learning processor/s 54 are retained independently at the decision set generator 56 as each type of process and/or model can have distinct and complementary uses as noted above.

As shown in FIG. 1, another aspect of the preferred system 10 is an ensemble module 60 that functions to combine, synthesize, aggregate, meld, and/or merge the independent decision sets into one or more artificial intelligence results, including for example a credit score and/or a set of questions suitable to ask the potential borrower in generating a final underwriting decision. Preferably, multiple methods or modes are utilized in the ensemble module 60 to evaluate the independent decision sets, such as for example a voting process or a winner-take-all process, either of which can be performed on raw or weighted values derived from the independent decision sets. Preferably, the ensembled data is directed to a model processing unit 70. The model processing unit 70 preferably functions to generate one or more of a model creditworthiness score or a model question set usable by the preferred system 10 in arriving at its underwriting decision. Any and all of the borrower data, model creditworthiness score, model question set, and/or any other relevant decision data can be directed to a data compiler 80 for storage and delivery to a user device 30 to complete the underwriting process.

As shown in FIG. 1, the preferred system 10 can further include and/or interface with a user device 30, which preferably functions to interface with a user to direct or assist in arriving at an underwriting decision. Typically it is a user, who can be any suitable individual or entity from whom the borrower seeks credit, who finalizes underwriting decisions. A preferred user interacts with the preferred system 10 with his or her user device 30, which can include a desktop computer, laptop computer, tablet computer, smart phone, personal digital assistant, or any other suitable networking device. For example, the user device 30 can include a desktop computer having a web browser or stand-alone application configured to interface with and/or receive any or all data to/from one or more components of the preferred system 10. Preferably, the user device permits a user to access the resources of the system 10 in order to assist in generating or partially generating an underwriting decision for each borrower.

As shown in FIG. 3, the preferred system 10 can assist in generating a final score 106 usable in making an underwriting decision. A preferred final score 106 can be a function of the creditworthiness score 100 (generated at the ensemble module 60), a model answer score 102 (derived by answers to model questions generated at the ensemble module 60), and/or a standard answer score 104 (generated by one of the borrower profile, user interaction with the borrower, or any other suitable scoring system). In one example implementation of the preferred system 10, a borrower uploads his or her borrower profile into the central computer 20 for processing, which in turn generates at least a creditworthiness score 100 and a set of model questions, each of which are directed to the user device 30. Preferably, the model questions are questions for which the answer is readily verifiable using one or both of the statistical or machine learning algorithms noted above. For example, a model question might include, “How long have you lived at this address?” which enables the preferred system 10 to compare the borrower's verbal answer with the quantitative results derived by the statistical and/or machine learning algorithms. Preferably, answers to the model questions are in the form of numbers, nominal or ordinal data, or logical values to permit easy comparison with the data generated by the preferred system 10. Upon receipt at the user device 30, a user can call, email, chat, or personally interact with the prospective borrower to ask any standard questions, model questions, and/or retrieve any other necessary data. Following the interaction between the user and the borrower, the user can input one or more additional data sets, such as model answers and/or standard answers, into the central computer for additional processing and generation of a final score 106. Upon receipt of the final score 106, preferably the user is in a position to extend or deny the requested credit based on the comprehensive and automated profiling of the borrower described herein.

### Preferred Method

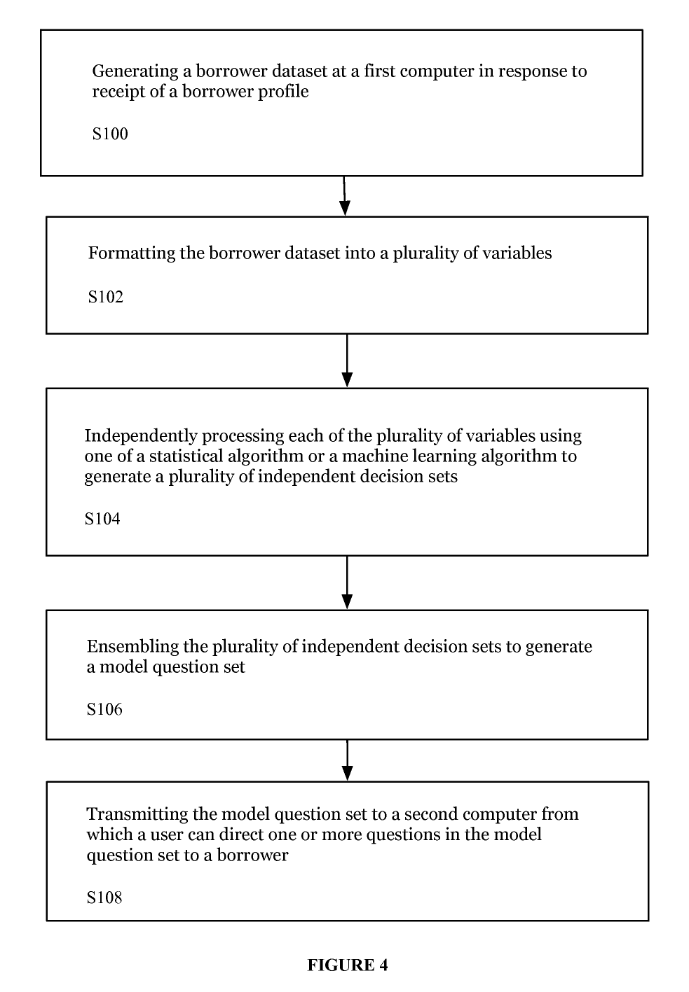

As shown in FIG. 4, a method for providing credit to underserved borrowers in accordance with a preferred embodiment can include generating a borrower dataset at a first computer in response to receipt of a borrower profile in block S100; formatting the borrower dataset into a plurality of variables in block S102, and independently processing each of the plurality of variables using one of a statistical algorithm or a machine learning algorithm to generate a plurality of independent decision sets in block S104. As shown in FIG. 4, the preferred method can further include ensembling the plurality of independent decision sets to generate a model question set in block S106; and transmitting the model question set to a second computer from which a user can direct one or more questions in the model question set to a borrower in block S108. The preferred method functions to provide credit to underbanked individuals by accessing, evaluating, measuring, quantifying, and utilizing a measure of creditworthiness based on very large scale data accumulation, processing, and analysis.

As shown in FIG. 4, the preferred method can include block S100, which recites generating a borrower dataset at a first computer in response to receipt of a borrower profile. Block S100 preferably functions to acquire, capture, scrape, mine, accumulate, and/or generate a dataset representing a plurality of aspects of the borrower's biographical and/or financial condition in response to a profile submitted by the borrower. Preferably, block S100 is performed by a central computer and/or user computer of the types described above, although any suitable machine, virtual machine, computing platform, server, database, server cluster, cloud computing system, or any combination thereof. Preferably, generating the borrower dataset can include receiving a first score from a proprietary source and scraping publicly available content on the Internet. For example, the first score can include a borrower's computed credit rating (FICO score) from any suitable credit rating agency available in the United States or abroad. Preferably, receiving the public data can include performing one or more search strings, automated crawls, or scrapes using any suitable searching, crawling, or scraping process, program, or protocol. Preferably, the public data can include data relating to a borrower's social network, including any data related to a borrower profile and/or any bogs, posts, tweets, links, friends, likes, connections, followers, followings, pins (collectively a borrower's social graph) on a social network. Additionally, the social network data can include any social graph information for any or all members of the borrower's social network. Suitable sources of social network data can include one or more social networking and/or blogging websites, including for example Google+, Facebook, Twitter, LinkedIn, Pinterest, tumblr, blogspot, and Myspace. Preferably, block S100 can generate tens of thousands of data points from dozens of data sources in a substantially instantaneous manner (e.g., approximately ten seconds or less per borrower).

As shown in FIG. 4, the preferred method can further include block S102, which recites formatting the borrower dataset into a plurality of variables. Block S102 functions to optimize the format of the borrower dataset acquired in block S100. The borrower dataset is preferably acquired in any suitable form, including native forms, which may or may not be amenable to systematic processing. As noted above, acquired raw data can include data in the form of strings, true/false flags, counters, URLs, borrower social graphs, borrower's friends' social graphs, and the like. Block S102 preferably organizes and/or quantizes each of the raw data formats into an appropriate data distribution for statistical and/or machine learning processing. As noted above, the format of the borrower's address data can be transformed such that a useful statistical analysis can be performed. For example, the preferred method can utilize any one or more of: Jaccard distances Mahalanobis distances, Hamming distances, non-normally distributed distances, traditional Euclidean distances measure, and/or high-order distance measures such as Cosine transforms to determine the likelihood that two listed addresses are in fact the same address. In another example noted above, a borrower's bankruptcy history is also of interest to potential underwriters. One variation of the preferred method addresses both the number of total bankruptcy filings as well as the time since the last bankruptcy filing. Block S102 preferably transforms and compiles each of the data entries into a suitable number of variables that are representative of the credit risk of the borrower. In another variation of the preferred method, block S102 converts the borrower dataset into thousands of variables in a predetermined format for independent processing.

As shown in FIG. 4, the preferred method can further include block S104, which recites independently processing each of the plurality of variables using one of a statistical algorithm or a machine-learning algorithm to generate a plurality of independent decision sets. Block S104 preferably functions to receive the plurality of variables generated in block S102 and calculate, determine, compute, and/or generate a plurality of independent data sets representative of the borrower's underwriting risk. Preferably, block S104 can include performing and/or executing one or more of statistical processing or machine learning processing in order to generate independent data sets that can be analyzed, combined, weighted, and/or modified singly or jointly to assess the borrower's underwriting risk. In one variation of the preferred method, block S104 can include using multiple statistical processing algorithms in concert with multiple machine learning algorithms in order to generate the independent data sets. In another variation of the preferred method, independently processing each of the plurality of variables can include directing the plurality of variables into one or both of several dozen statistical algorithms and/or machine learning algorithms, the computations from all of which can be independently utilized to generate the independent decision sets. As noted above, suitable statistical algorithms can include logistic regression models, item-response theory models, structural equation models, Bayesian networks, naïve Bayesian models, general linear models, Euclidean distance metrics, non-Euclidean distance metrics, collaborative filtering, and/or K-means clustering. Suitable machine learning algorithms can include decision trees, naïve Bayesian models, random forest algorithms, a graph theoretical algorithm, a swarm algorithm, a simulated annealing algorithm, support vector machines, expectation maximization-based clustering models, hill climbing models, artificial neural networks, various algorithms using a kernel trick to redistribute values, non-negative matrix factorization, and/or genetic algorithms.

As shown in FIG. 8, another variation of the preferred method can include block S116, which recites independently evaluating each output from a plurality of statistical algorithms a plurality of machine-learning algorithms to generate the independent decision set. Each of the various statistical algorithms and machine learning algorithms can be configured for computing, determining, and/or calculating one or more aspects or features of the borrower's underwriting risk. For example, a support vector machine is suitable for eliminating borrower's with extreme risk values; and a naïve Bayesian model is suitable for overcoming missing data that for one reason or another is not captured or available in performance of the preferred method. Accordingly, block S116 preferably functions to maintain the independent value for each individual statistical algorithm and/or machine learning algorithm so as to avoid dilution of the value of each algorithm. In another variation of the preferred method, the independently evaluated outputs are compiled into independent decision sets for each borrower, each of which can be evaluated, weighted, blended, and/or merged into a comprehensive understanding of the borrower's credit risk as described below.

As shown in FIG. 4, the preferred method can further include block S106, which recites ensembling the plurality of independent decision sets to generate a model question set. Block S106 preferably functions to combine, synthesize, aggregate, meld, and/or merge the independent decision sets into one or more artificial intelligence results, including for example a credit score and/or a set of questions suitable to ask the potential borrower in generating a final underwriting decision. In one variation of the preferred method, block S106 can include one or both of voting for a selected value for each of the independent decision sets and/or selecting a single value for each of the independent decision sets. Preferably, the ensembled data is used to generate one at least a model question set for a user in arriving at its underwriting decision. In one variation of the preferred method, the model question set can include one or more questions that lead to objectively verifiable and confirmable responses from the borrower. Model responses to the model questions are preferably formed or formatted as numbers, nominal or ordinal data, or logical values for ease of comparison with the previously derived data sets. As noted above, an example model question might include, “How long have you lived at this address?” which has a numerical answer (e.g., fourteen months) and therefore enables the preferred method to compare the borrower's verbal answer with the quantitative results derived by the statistical and/or machine learning algorithms. Preferably, the preferred method can further include block S108, which recites transmitting the model question set to a second computer from which a user can direct one or more questions in the model question set to a borrower.

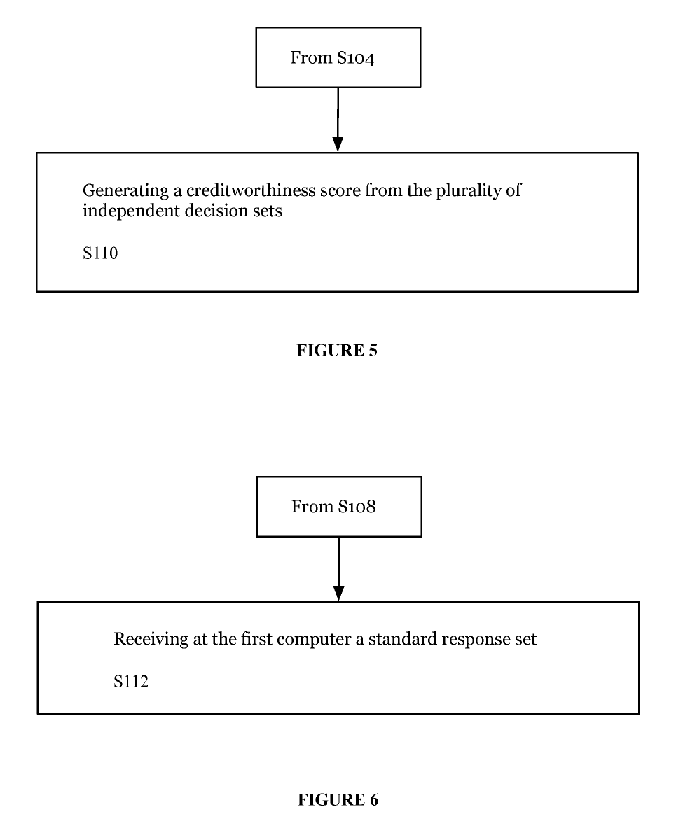

As shown in FIG. 5, another variation of the preferred embodiment can include block S110, which recites generating a creditworthiness score from the plurality of independent decision sets. Block S110 can function to calculate, compute, determine, and/or generate an objective metric or score of the borrower's potential credit risk that is distinct from the standard FICO score and based at least in part on the processing of the borrower dataset described above. The creditworthiness score is preferably generated substantially simultaneously with the ensembling of the plurality of independent decision sets and in generating the model question set. Preferably, both the creditworthiness score and the model set of questions can be transmitted to the second computer in block S108. A suitable second computer can include one or both of a central computer and/or a user computer of the types described above.

As shown in FIG. 6, another variation of the preferred method can further include block S112, which recites receiving at the first computer a standard response set. Block S112 preferably functions to acquire, capture, and/or receive a set of borrower responses to one or more predetermined or standardized credit application questions. In one alternative implementation, the standard response set can be received with or as part of the borrower profile data that the preferred method acquired prior to execution of block S100. In another alternative implementation, the standard response set can be received following and/or in addition to responses to one or more questions in the model question set generated in block S106. Preferably, the standard response set can be introduced into the preferred method at or for any appropriate act, such that the standard response set can compose at least a portion of the borrower dataset upon which the computations blocks S102, S104, S106, and S108 are based. Alternatively, the standard response set can be transmitted directly from the first computer to the second computer for receipt and action by the user of the second computer (e.g., the underwriter). In still another alternative implementation, block 5112 can include transmitting the standard response set to the second computer in addition to or in lieu of the first computer for direct processing and action by the user of the second computer.

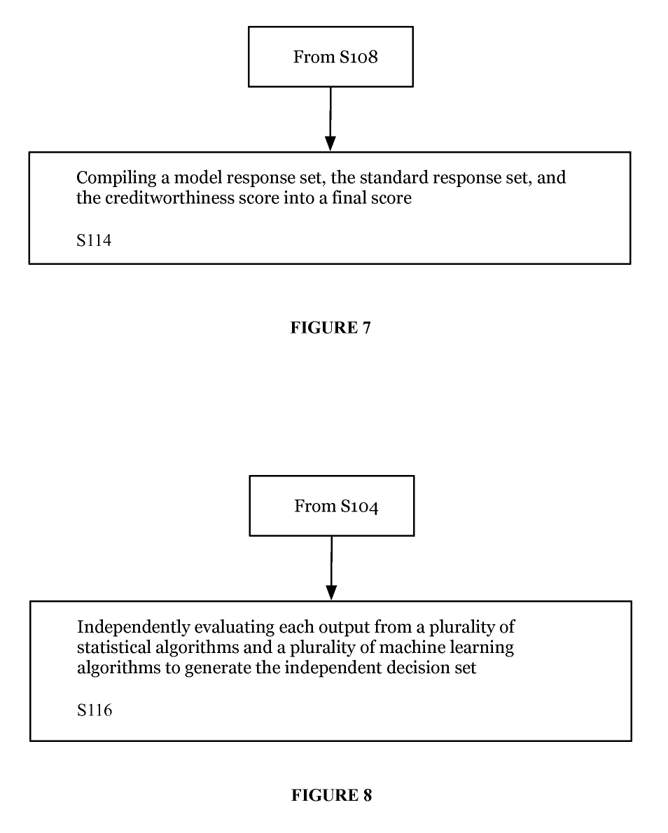

As shown in FIG. 7, another variation of the preferred method can include block S114, which recites compiling a model response set, the standard response set, and the creditworthiness score into a final score. Block S114 is preferably performed at one or both of the user device and/or the central computer. In one example implementation, the standard response set and the model response set can be received at the first computer and transmitted, either alone or in combination with the creditworthiness score, to the central computer for compilation into a final score. Alternatively, the compilation and determination of the final score can be accomplished by and/or at the user computer such that the user can make an underwriting decision directly without further interaction with the central computer. As noted above, one example implementation of the preferred method can include receiving a borrower profile at a central computer for processing, which in turn generates at least a creditworthiness score and a set of model questions, each of which are directed to the user device. The user can call, email, chat, or personally interact with the prospective borrower to ask any standard questions, model questions, and/or retrieve any other necessary data. Following the interaction between the user and the borrower, the user can input one or more additional data sets, such as model answers and/or standard answers, into the central computer for additional processing and generation of a final score in block S114. As noted above, upon receipt of the final score, preferably the user is in a position to extend or deny the requested credit based on the comprehensive and automated profiling of the borrower described herein.

Aspects of the system and method of the preferred embodiment can be embodied and/or implemented at least in part as a machine configured to receive a computer-readable medium storing computer-readable instructions. The instructions are preferably executed by computer-executable components preferably integrated with the borrower device 12, the user device 30, the central computer 20 and the various components thereof, and/or any of the raw datasets 14, 16, 18. Other systems and methods of the preferred embodiment can be embodied and/or implemented at least in part as a machine configured to receive a computer-readable medium storing computer-readable instructions. The instructions are preferably executed by computer-executable components preferably integrated by computer-executable components preferably integrated with a central computer 20 or user device 30 of the type described above. The computer-readable medium can be stored on any suitable computer readable media such as RAMs, ROMs, flash memory, EEPROMs, optical devices (CD or DVD), hard drives, floppy drives, or any suitable device. The computer-executable component is preferably a processor but any suitable dedicated hardware device can (alternatively or additionally) execute the instructions.

As a person skilled in the art will recognize from the previous detailed description and from the figures and claims, modifications and changes can be made to the preferred embodiments of the invention without departing from the scope of this invention defined in the following claims.

1-27. (canceled)

28. A central computing system, having a processor, communicatively coupled to a public network and configured to assess an underbanked borrower's credit risk for a credit application electronically submitted by the underbanked borrower comprising:
a phone system communicatively coupled to the public network;
a web-based interface communicatively coupled to the public network; and
a computer-usable medium with a sequence of instructions which, when executed by the processor, causes said processor to execute an electronic process that assesses the underbanked borrower's credit risk for the credit application, said process comprising:
(a) providing the underbanked borrower an electronic interface over the public network through the web-based interface that enables the underbanked borrower to submit a credit application and input personal data in response to a set of requests provided by the electronic interface;
(b) enabling a real-time phone call via the phone system between the underbanked borrower and a financial representative to verify and/or extend the personal data inputted by the underbanked borrower via the electronic interface;
(c) searching databases over the public network for public data related to the underbanked borrower's personal data; and
(d) calculating a first credit risk value for the underbanked borrower based on the data collected from at least steps (a) and (c), wherein the central computing system generates a signal that indicates a denial of the underbanked borrower's credit application if the first credit risk value does not meet a first credit risk threshold; and
(e) calculating a second credit risk value for the underbanked borrower based on the data collected from steps (a), (b), and (c),
wherein the first and second credit risk values are electronically calculated without use of the underbanked borrower's credit rating established by a credit rating agency, and
further wherein the central computing system is enabled to calculate the first and second credit risk values when the underbanked borrower's personal data is missing data responsive to one or more of the requests in the set of requests provided by the electronic interface in step (a).
